(19) United States
(12) Patent Application Publication
(10) Pub. No.: US 2022/0234462 A1
(43) Pub. Date: Jul. 28, 2022

(54) POWER TRANSMISSION APPARATUS, AND POWER TRANSMISSION SYSTEM

(71) Applicant: TDK CORPORATION, Tokyo (JP)

(72) Inventor: Akihiro Ii, Tokyo (JP)

(73) Assignee: TDK CORPORATION, Tokyo (JP)

(21) Appl. No.: 17/560,470

(22) Filed: Dec. 23, 2021

(30) Foreign Application Priority Data
Jan. 26, 2021 (JP) 2021-010709

(51) Int. Cl. B60L 53/39; B60L 53/126; H02J 50/10

(52) U.S. Cl. CPC B60L 53/39; H02J 50/10; B60L 53/126

(57) ABSTRACT

A power transmission coil unit includes a power transmission coil formed such that a lead wire is spirally wound around a coil axis extending in a first direction. Sensor modules each include a sensor having a detection range of a first angle that is a detection angle spanning in an in-plane direction of a first plane orthogonal to the first direction. The sensors are disposed in a surrounding region that is, as viewed in the first direction, a region surrounding the power transmission coil unit along an outer edge of the power transmission coil unit. The sensors are disposed such that a second angle or an angle between a straight line overlapping the detection range, among straight lines constituting the outer edge of the power transmission coil unit, and a center axis of the detection range is ½ or less of the first angle.

### CROSS-REFERENCE TO RELATED APPLICATION

This application claims the benefit of Japanese Patent Application No. 2021-10709, filed on Jan. 26, 2021, the entire disclosure of which is incorporated by reference herein.

### FIELD

This application relates generally to a power transmission apparatus, and a power transmission system.

### BACKGROUND

Attention has been paid to wireless power transmission technology that wirelessly transmits electric power. Since the wireless power transmission technology enables wireless transmission of electric power from a power transmission apparatus to a power receiving apparatus, it is expected that the wireless power transmission technology is applied to various products, for example, transport equipment such as an electric train or an electric vehicle, household electrical equipment, wireless communication equipment, and toys. In the wireless power transmission technology, a power transmission coil and a power receiving coil, which are coupled by magnetic flux, are used in order to transmit electric power.

In the meantime, if an object such as a living body or a metal piece is present near the power transmission coil, there is a possibility that various problems will arise. For example, when a living body is present near the power transmission coil, there is a possibility that the living body is exposed to an electromagnetic field occurring at the time of power transmission, and a health problem arises in the living body. Accordingly, there is a demand for an object detection apparatus that properly detects an object existing near the power transmission coil.

Unexamined Japanese Patent Application Publication No. 2014-57457 discloses a non-contact power supply system in which sensors that monitor a lateral surrounding of a power transmission coil are arranged around the power transmission coil in order to detect an entrance of a movable body into the lateral surrounding of the power transmission coil. Unexamined Japanese Patent Application Publication No. 2014-57457 discloses that a plurality of sensors is arranged such that a detection range of the sensor broadens toward the outside of the power transmission coil.

### SUMMARY

However, the detection range of this sensor is narrow in a region near the sensor. Thus, in the arrangement of the sensors disclosed in Unexamined Japanese Patent Application Publication No. 2014-57457, a detection blind spot, which is a region where an object cannot be detected, occurs in a region along the outer edge of the power transmission coil. This being the case, there is a demand for technology which reduces the detection blind spot near the periphery of the power transmission coil.

The present disclosure has been made in consideration of the above problem, and the objective of the disclosure is to reduce a detection blind spot near a periphery of a power transmission coil, in the object detection involved in wireless power transmission.

In order to solve the above problem, a power transmission apparatus according to an embodiment of the present disclosure includes:

a power transmission coil unit including a power transmission coil formed such that a lead wire is spirally wound around a coil axis extending in a first direction, the power transmission coil unit wirelessly transmitting electric power to a power receiving apparatus;

a plurality of sensor modules each including a sensor and a controller, the sensor having a detection range of a first angle that is a detection angle spanning in an in-plane direction of a first plane orthogonal to the first direction, the controller being configured to control the sensor and generate output information based on a signal that the sensor outputs; and

a detector that determines presence or absence of an object, based on the output information, wherein

an outer edge of the power transmission coil unit, as viewed in the first direction, has a shape including a plurality of straight lines,

the plurality of sensors is disposed in a surrounding region that is, as viewed in the first direction, a region surrounding the power transmission coil unit along the outer edge of the power transmission coil unit, and

each of the plurality of sensors, as viewed in the first direction, is disposed such that a second angle that is an angle formed between a straight line overlapping the detection range, among the plurality of straight lines constituting the outer edge of the power transmission coil unit, and a center axis of the detection range is ½ or less of the first angle.

According to the above configuration, a detection blind spot near a periphery of a power transmission coil can be reduced in the object detection involved in wireless power transmission.

### BRIEF DESCRIPTION OF THE DRAWINGS

A more complete understanding of this application can be obtained when the following detailed description is considered in conjunction with the following drawings, in which:

FIG. 1 is a schematic configuration diagram of a power transmission system according to Embodiment 1;

FIG. 2 is a perspective view of a power transmission coil unit and a power receiving coil unit according to Embodiment 1;

FIG. 3 is a top view of a sensor module according to Embodiment 1;

FIG. 4 is a configuration diagram of an object detection apparatus according to Embodiment 1;

FIG. 5 is an explanatory diagram of a detection range of a sensor according to Embodiment 1;

FIG. 6 is an arrangement diagram of sensor modules according to Embodiment 1;

FIG. 7 is an explanatory diagram of an installation angle of the sensor module according to Embodiment 1;

FIG. 8 is an arrangement diagram of sensor modules according to Embodiment 2;

FIG. 9 is an explanatory diagram of an arrangement of a pair of sensor modules;

FIG. 10 is an arrangement diagram of sensor modules according to Embodiment 3;

FIG. 11 is an arrangement diagram of sensor modules according to Embodiment 4; and

FIG. 12 is an arrangement diagram of sensor modules according to Embodiment 5.

### DETAILED DESCRIPTION

Hereinafter, a power transmission system according to an embodiment of a technology relating to the present disclosure is described with reference to the accompanying drawings. Note that in the embodiment to be described below, the same structural parts are denoted by the same reference signs. In addition, the ratios in magnitude and the shapes of the structural elements illustrated in the drawings are not necessarily the same as the actual ones.

### Embodiment 1

A power transmission system according the present embodiment is usable for charging secondary batteries of various apparatuses, for instance, an electric vehicle (EV), mobile equipment such as a smartphone, and industrial equipment. Hereinafter, a description is given of, by way of example, a case of charging a rechargeable battery of an EV by a power transmission system.

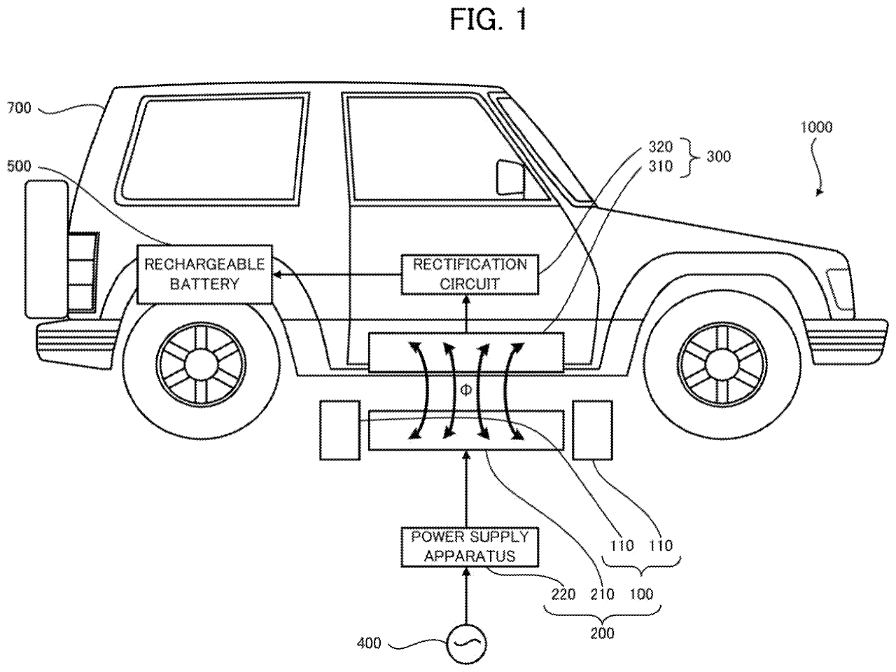

FIG. 1 is a schematic configuration diagram of a power transmission system 1000 that is used for charging a rechargeable battery 500 included in an electric vehicle 700. The electric vehicle 700 runs by using, as a driving source, a motor that is driven by electric power that is charged in the rechargeable battery 500 such as a lithium ion battery or a lead storage battery. The electric vehicle 700 is an example of a movable body.

As illustrated in FIG. 1, the power transmission system 1000 is a system that wirelessly transmits electric power from a power transmission apparatus 200 to a power receiving apparatus 300 by magnetic coupling. The power transmission system 1000 includes a power transmission apparatus 200 that wirelessly transmits electric power of an alternating-current (AC) or direct-current (DC) commercial power source 400 to the electric vehicle 700; and a power receiving apparatus 300 that receives the electric power transmitted by the power transmission apparatus 200 and charges the rechargeable battery 500. Note that in the description below, the commercial power source 400 is an AC power source.

The power transmission apparatus 200 is an apparatus that wirelessly transmits electric power to the power receiving apparatus 300 by magnetic coupling. The power transmission apparatus 200 includes an object detection apparatus 100 that detects an object; a power transmission coil unit 210 that transmits AC power to the electric vehicle 700; and a power supply apparatus 220 that supplies AC power to the power transmission coil unit 210. A detailed description of the object detection apparatus 100 is given later.

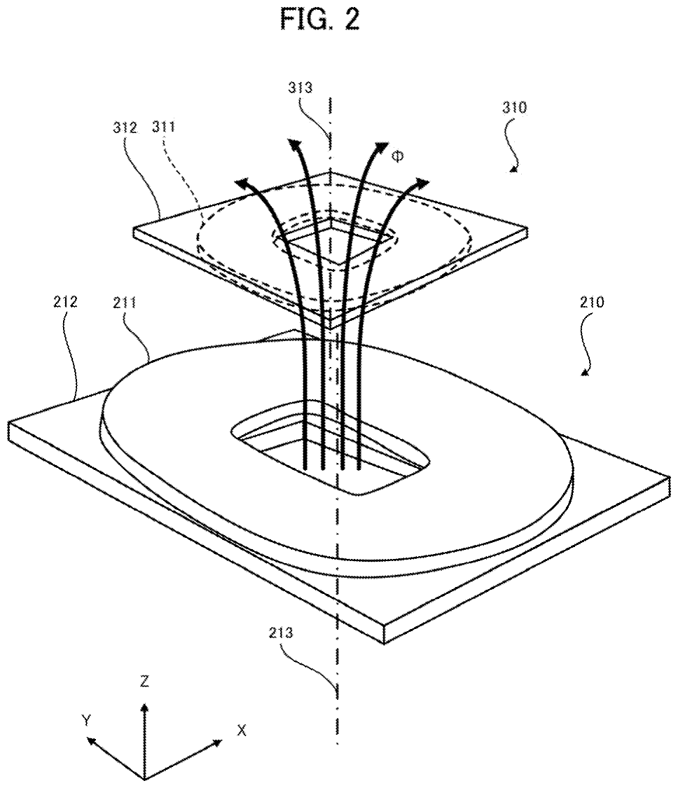

FIG. 2 illustrates a main part of the power transmission coil unit 210, and a main part of the power receiving coil unit 310. As illustrated in FIG. 2, the power transmission coil unit 210 includes a power transmission coil 211 that is supplied with AC power from the power supply apparatus 220 and induces an alternating magnetic flux 1; and a magnetic material plate 212 that passes magnetic force generated by the power transmission coil 211 and suppresses a loss of the magnetic force. The power transmission coil 211 is composed such that a lead wire is spirally wound around a coil axis 213 on the magnetic material plate 212. The power transmission coil 211 and capacitors provided at both ends of the power transmission coil 211 constitute a resonance circuit, and an alternating magnetic flux 1 is induced by the flow of an AC current due to the application of an AC voltage. In FIG. 2, an axis in a vertically upward direction is a Z-axis, an axis orthogonal to the Z-axis is an X-axis, and an axis orthogonal to the Z-axis and X-axis is a Y-axis.

The magnetic material plate 212 has a plate shape with a hole formed in a central portion of the magnetic material plate 212, and is formed of a magnetic material. The magnetic material plate 212 is, for example, a plate-shaped member formed of a ferrite that is a composite oxide of an iron oxide and a metal. Note that the magnetic material plate 212 may be composed of an aggregate of a plurality of magnetic material pieces, and the magnetic material pieces may be arranged in a frame shape, with an opening portion provided in a central portion of the arranged magnetic material pieces.

The power supply apparatus 220 includes a power factor improvement circuit that improves the power factor of the commercial AC power that is supplied by the commercial power source 400; and an inverter circuit that generates AC power which is supplied to the power transmission coil 211. The power factor improvement circuit rectifies and boosts the AC power generated by the commercial power source 400, and converts the AC power to DC power having a preset voltage value. The inverter circuit converts the DC power, which was generated by the conversion of electric power by the power factor improvement circuit, to AC power having a preset frequency. The power transmission apparatus 200 is fixed to, for example, the floor surface of a parking lot.

The power receiving apparatus 300 is an apparatus which wirelessly receives electric power from the power transmission apparatus 200 by magnetic coupling. The power receiving apparatus 300 includes a power receiving coil unit 310 that receives AC power transmitted by the power transmission apparatus 200; and a rectification circuit 320 that converts the AC power supplied from the power receiving coil unit 310 to DC power, and supplies the DC power to the rechargeable battery 500.

As illustrated in FIG. 2, the power receiving coil unit 310 includes a power receiving coil 311 that induces electromotive force in accordance with a variation of the alternating magnetic flux 1 induced by the power transmission coil 211; and a magnetic material plate 312 that passes magnetic force generated by the power receiving coil 311 and suppresses a loss of the magnetic force. The power receiving coil 311 is composed such that a lead wire is spirally wound around a coil axis 313 on the magnetic material plate 312. The power receiving coil 311 and capacitors provided at both ends of the power receiving coil 311 constitute a resonance circuit.

In the state in which the electric vehicle 700 is at rest in a preset position, the power receiving coil 311 is opposed to the power transmission coil 211. If the power transmission coil 211 receives electric power from the power supply apparatus 220 and induces an alternating magnetic flux 1, the alternating magnetic flux 1 is interlinked with the power receiving coil 311, and thereby induced electromotive force is induced in the power receiving coil 311.

The magnetic material plate 312 is plate-shaped member with a hole formed in a central portion of the magnetic material plate 312, and is formed of a magnetic material. The magnetic material plate 312 is, for example, a plate-shaped member formed of a ferrite that is a composite oxide of an iron oxide and a metal. Note that the magnetic material plate 312 may be composed of an aggregate of a plurality of magnetic material pieces, and the magnetic material pieces may be arranged in a frame shape, with an opening portion provided in a central portion of the arranged magnetic material pieces.

The rectification circuit 320 rectifies the electromotive force induced in the power receiving coil 311, and generates DC power. The DC power generated by the rectification circuit 320 is supplied to the rechargeable battery 500. Note that the power receiving apparatus 300 may include, between the rectification circuit 320 and the rechargeable battery 500, a charge circuit that converts the DC power supplied from the rectification circuit 320 to appropriate DC power for charging the rechargeable battery 500. The power receiving apparatus 300 is fixed to, for example, the chassis of the electric vehicle 700.

The object detection apparatus 100 is an apparatus that detects an object existing within a detection range. The detection range is a range in which an object can be detected. The detection range is a region near the power transmission coil unit 210 and the power receiving coil unit 310. As objects that the object detection apparatus 100 detects, a living body and a metal piece are mainly conceivable. As living bodies, animal bodies of a dog, a cat and the like, as well as the human body, are conceivable.

If a living body exists within the detection range at the time of power transmission, there is a possibility that the living body is exposed to an electromagnetic field, and a health problem arises in the living body. In addition, if a metal piece exists within the detection range at the time of power transmission, there is a possibility that the metal piece adversely affects the power transmission, and generates heat. Thus, the object detection apparatus 100 detects an object existing within the detection range, and notifies a user that the object was detected. Upon receiving the notification, the user can move the object away from the detection range.

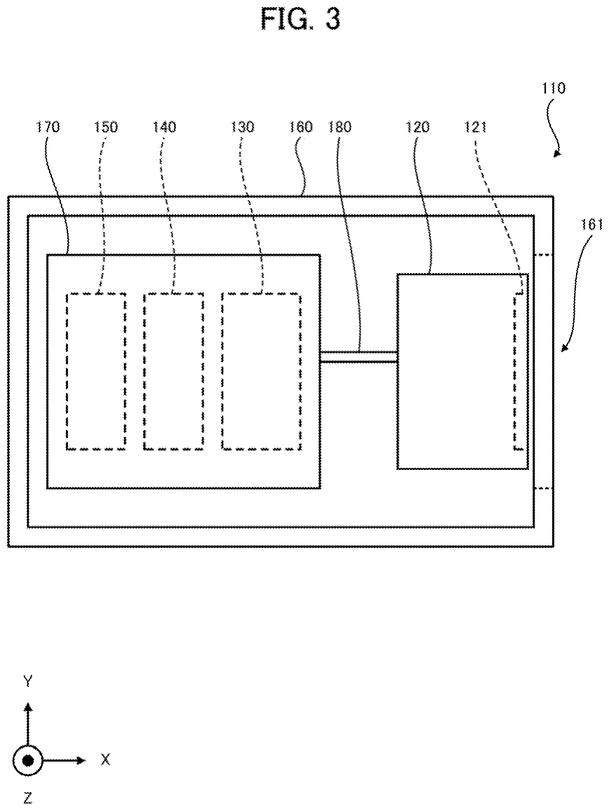

In the present embodiment, the object detection apparatus 100 includes a plurality of sensor modules 110. The sensor module 110 is a unit in which components used for detecting an object are integrated in one housing. Specifically, as illustrated in FIG. 3, the sensor module 110 includes a sensor 120 that detects an object; a housing 160 that accommodates the sensor 120 and a detection board 170; and the detection board 170 that is connected to the sensor 120 by a cable 180. In FIG. 3, for easier understanding, an illustration of a ceiling part of the housing 160 is omitted. In other words, FIG. 3 is a top view of the sensor module 110 at a time when the ceiling portion of the housing 160 is removed. Note that the structures and functions of the plurality of sensor modules 110 are basically the same.

The sensor 120 is a sensor that detects an object existing within the detection range. As the sensor 120, various types of sensors, such as a sensor that detects a reflective wave of a sound wave or an electromagnetic wave, and a sensor that detects an electromagnetic wave, can be adopted. For example, as the sensor 120, an ultrasonic sensor, a millimeter-wave sensor, an X-band sensor, an infrared sensor, and a visible-light sensor can be adopted. In the present embodiment, the sensor 120 is an ultrasonic sensor that transmits an ultrasonic wave by a transmitter, and receives a reflective wave of the ultrasonic wave by a receiver. Hereinafter, the ultrasonic wave that the transmitter transmits is referred to as a transmission wave, where appropriate.

The sensor 120 includes a piezoelectric element and a housing that accommodates the piezoelectric element. The sensor 120 executes sensing in accordance with control by a controller 130. The sensor 120 applies a voltage pulse, which is supplied from the controller 130, to the piezoelectric element, and transmits a transmission wave that is an ultrasonic wave from the piezoelectric element. In addition, the sensor 120 supplies to the controller 130 a voltage signal indicative of a voltage generated in the piezoelectric element by a reflective wave of the transmission wave.

The sensor 120 includes a detection window 121 through which the transmission wave and the reflective wave pass. The detection window 121 is, for example, an opening portion in the housing of the sensor 120, or a part in the housing of the sensor 120, which is formed of a member that less easily attenuates a sound wave or an electromagnetic wave. The sensor 120 radiates a transmission wave from the detection window 121, and receives a reflective wave through the detection window 121.

The housing 160 accommodates the sensor 120 and the detection board 170. The housing 160 is, for example, a box-shaped member including an opening portion 161 in a position opposed to the detection window 121 of the sensor 120. The housing 160 includes an electromagnetic shielding member that covers at least a part of the sensor 120. In the present embodiment, the electromagnetic shielding member covers at least a part of those portions of the sensor 120, which are other than the detection window 121. The electromagnetic shielding member is a member that suppresses the passage of electromagnetism, and is a member for suppressing the influence of magnetic flux by power transmission. The electromagnetic shielding member mainly functions to shield the sensor 120 from the influence of an electromagnetic field that the power transmission coil 211 generates. The electromagnetic shielding member is, for example, a member formed of aluminum.

The detection board 170 is a board on which components for executing various processes involved in the detection of an object are mounted. A central processing unit (CPU), a read-only memory (ROM), a random access memory (RAM), a real time clock (RTC), an analog/digital (A/D) converter, a flash memory, a communication interface, and the like are mounted on the detection board 170. The communication interface is a communication interface that supports, for example, well-known wired communication standards such as a universal serial bus (USB) (registered trademark) and Thunderbolt (registered trademark), or well-known wireless communication standards such as Wi-Fi (registered trademark), Bluetooth (registered trademark), long term evolution (LTE), 4th generation (4G), and 5th generation (5G). A controller 130, a storage 140, and a communicator 150, which are described later, are implemented by these structural components mounted on the detection board 170.

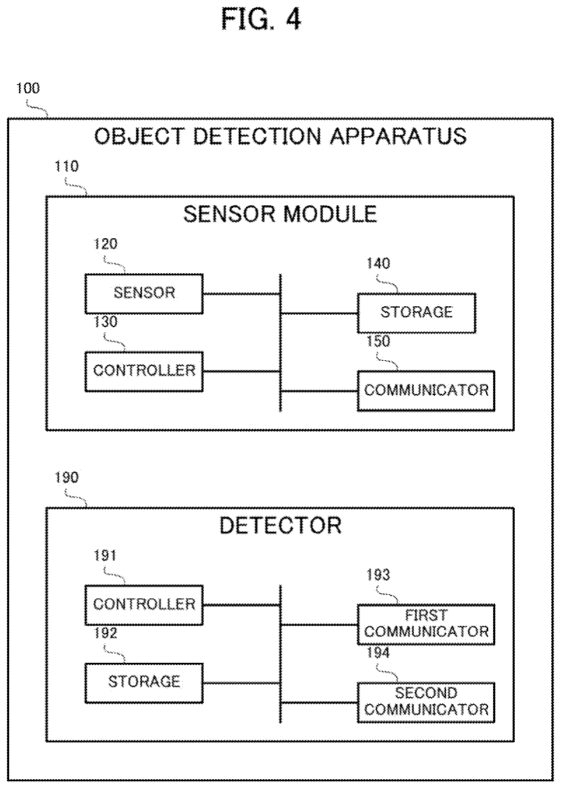

Next, referring to FIG. 4, a configuration of the object detection apparatus 100 is described. The object detection apparatus 100 includes a plurality of sensor modules 110, and a detector 190. Note that FIG. 4 explicitly illustrates only one sensor module 110. The sensor module 110 includes a sensor 120, a controller 130, a storage 140, and a communicator 150. The detector 190 includes a controller 191, a storage 192, a first communicator 193, and a second communicator 194. The detector 190 is provided outside the sensor module 110. For example, the detector 190 is provided in the inside of the housing of the power transmission coil unit 210 or power supply apparatus 220.

The controller 130 controls the operation of the entirety of the sensor module 110. The controller 130 controls the sensor 120 according to an operation program stored in the storage 140, and generates output information, based on a signal that the sensor 120 outputs. The controller 130 includes, for example, a CPU, a ROM, a RAM, an RTC, an A/D converter, and the like.

The controller 130 generates output information, based on a signal that the sensor 120 outputs. To begin with, the controller 130 drives the sensor 120 in accordance with control by the detector 190. Specifically, the controller 130 supplies to the sensor 120 a voltage pulse for causing the sensor 120 to transmit a transmission wave of an amplitude and a frequency designated by parameters stored in the storage 140. Based on the signal that the sensor 120 outputs, the controller 130 generates output information indicative of a detection result of the sensor 120. Specifically, the controller 130 executes an A/D conversion process and a filtering process on an analog signal that the sensor 120 outputs, and specifies a distance from the sensor 120 to an object, and an amplitude of a reflective wave.

The controller 130 outputs the output information including a value indicative of the specified distance and a value indicative of the specified amplitude. The output information acquired by the controller 130 is stored in the storage 140, where appropriate. In addition, the controller 130 transmits the acquired output information to the detector 190 via the communicator 150. The controller 130 may transmit the output information to the detector 190 in accordance with a request by the detector 190, or may transmit the output information to the detector 190, responding to the acquisition of the output information.

The storage 140 stores operation programs and data, which are used for the controller 130 to execute various processes. For example, the storage 140 stores parameters for the sensor 120. As the parameters, various kinds of parameters are conceivable. In the present embodiment, as the parameters, an amplitude of a transmission wave that is transmitted by the sensor 120, and a frequency of a transmission wave that is transmitted by the sensor 120, are adopted. In addition, the storage 140 stores data that the controller 130 generates or acquires by executing various processes. For example, the storage 140 stores output information acquired by the controller 130. The storage 140 includes, for example, a flash memory.

The communicator 150 is a communication interface for communicating with the detector 190. The communicator 150 includes a communication interface that supports a well-known wired communication standard, or includes a communication interface that supports a well-known wireless communication standard.

The detector 190 determines the presence or absence of an object, based on the output information acquired from the sensor module 110. The controller 191 controls the operation of the entirety of the detector 190. The controller 191 acquires output information from the sensor module 110 according to an operation program stored in the storage 192, and detects an object, based on the output information. The controller 191 includes, for example, a CPU, a ROM, a RAM, an RTC, an A/D converter, and the like.

Specifically, the controller 191 transmits the parameters stored in the storage 192 to the sensor module 110 via the first communicator 193. In addition, the controller 191 instructs the sensor module 110 to detect an object, via the first communicator 193. For example, the controller 191 instructs the sensor module 110 to detect an object, at a time of powering on the object detection apparatus 100, or at a time of receiving an instruction from the power transmission coil unit 210 or the power supply apparatus 220. The controller 191 acquires the output information from the sensor module 110 via the first communicator 193.

The controller 191 determines the presence or absence of an object, based on the acquired output information. The controller 191 executes various notification processes in accordance with the determination result. For example, when an object was successively detected a predetermined number of times, the controller 191 makes notification indicating the presence of an object. Note that the destination of notification is the power transmission coil unit 210, the power supply apparatus 220, a terminal apparatus (not shown), or the like.

The storage 192 stores operation programs and data, which are used for the controller 191 to execute various processes. For example, the storage 192 stores parameters for the sensor 120. In addition, the storage 192 stores data that the controller 191 generates or acquires by executing various processes. For example, the storage 192 stores output information acquired by the controller 191. The storage 192 includes, for example, a flash memory.

The first communicator 193 is a communication interface for communicating with the sensor module 110. The first communicator 193 includes a communication interface that supports a well-known wired communication standard, or includes a communication interface that supports a well-known wireless communication standard. The second communicator 194 is a communication interface for communicating with the power transmission coil unit 210, the power supply apparatus 220, an external terminal apparatus (not shown), and the like. The second communicator 194 includes a communication interface that supports a well-known wired communication standard, or includes a communication interface that supports a well-known wireless communication standard.

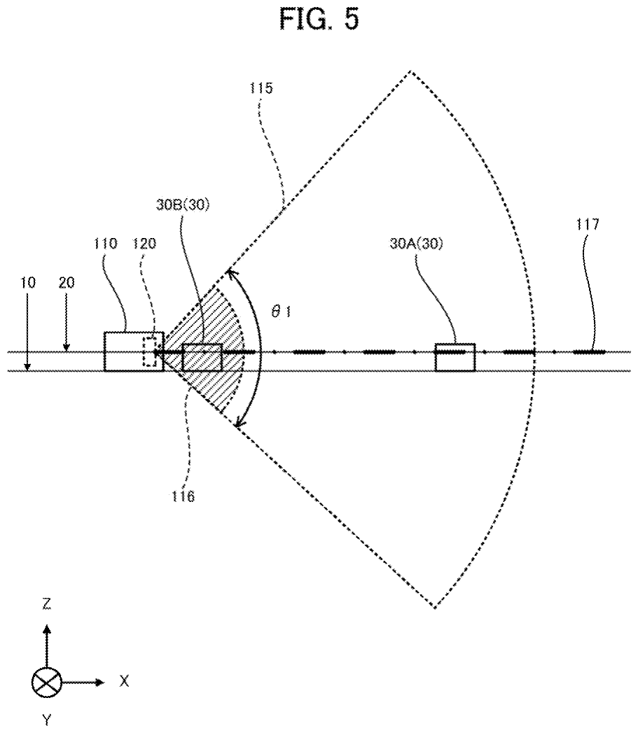

Next, referring to FIG. 5, a detection range 115 of the sensor 120 included in the sensor module 110 is described. FIG. 5 is a diagram illustrating the detection range 115 of the sensor 120 in a case where the sensor module 110 is disposed such that a detection direction of the sensor 120 is directed toward a positive direction of the X-axis.

A plane 10 is a plane orthogonal to the Z-axis, and is a plane on which the sensor module 110 is disposed. A plane 20 is a plane orthogonal to the Z-axis, and a plane including a center axis 117 of the detection range 115. An object 30A is an object disposed in such a position that the sensor 120 can detect the object 30A. An object 30B is an object disposed in such a position that the sensor 120 cannot detect the object 30B. Hereinafter, the object 30A and the object 30B are comprehensively referred to as an object 30 where appropriate.

The detection range 115 is a range within which the sensor 120 can detect the object 30. A non-detection range 116 is a range within which the sensor 120 can hardly detect the object 30. The non-detection range 116 is a range corresponding to a region, the distance of which from the sensor 120 is a minimum detectable distance or less. The non-detection range 116 is a range corresponding to a first region that becomes broader as a distance from a vertex, which is set at the position of the sensor 120, becomes greater. The detection range 115 is a range corresponding to a region that is defined by excluding the first region from a second region that includes the first region and becomes broader as a distance from a vertex, which is set at the position of the sensor 120, becomes greater. The center axis 117 is a center axis of the detection range 115. θ1 is a detection angle spanning in an in-plane direction of a plane that is orthogonal to the Y-axis and includes the center axis 117. In the present embodiment, θ1 is 90 degrees.

The sensor 120 can detect an object 30, which is disposed at a position that is neither excessively close to nor excessively far from the sensor 120, among objects 30 existing in an extending direction of the center axis 117, as viewed from the sensor 120. Specifically, the sensor 120 can detect the object 30A disposed within the detection range 115 that is neither excessively close to nor excessively far from the sensor 120. On the other hand, the sensor 120 cannot detect the object 30B disposed in the non-detection range 116 that is excessively close to the sensor 120. In this manner, the sensor 120 can detect neither the object 30 disposed at an excessively far position, nor the object 30 disposed at an excessively close position.

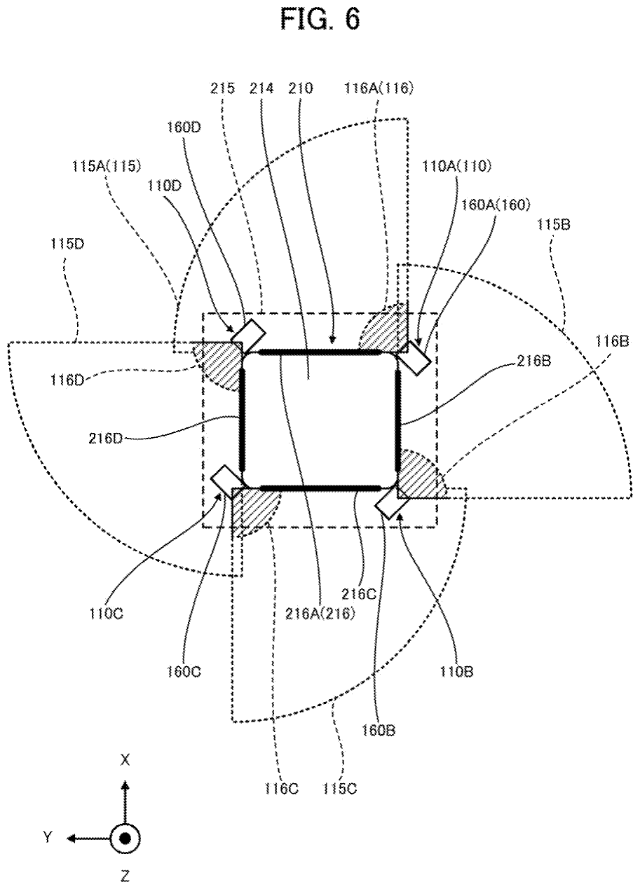

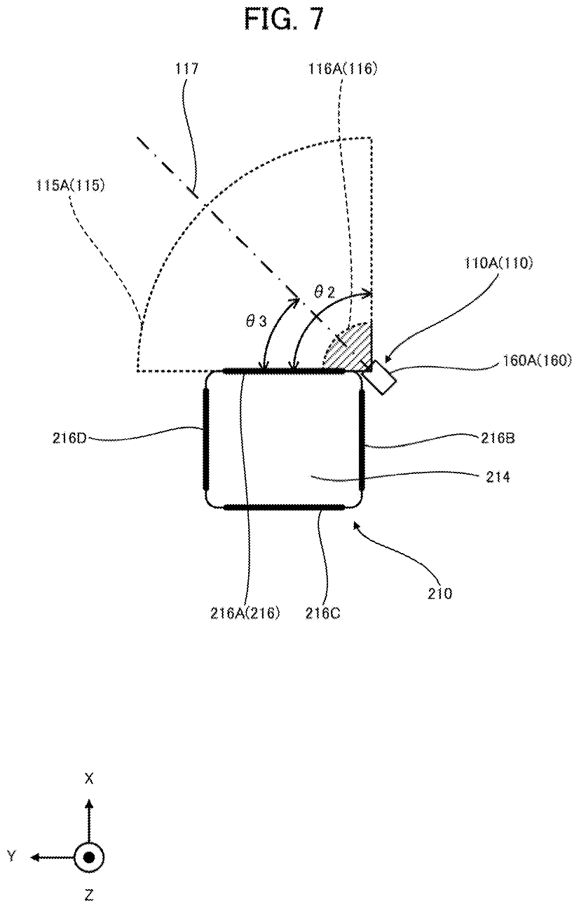

Next, referring to FIG. 6 and FIG. 7, installation positions and installation angles of the sensor modules 110 is described. FIG. 6 is an arrangement diagram of four sensor modules 110 included in the object detection apparatus 100. FIG. 7 is an explanatory diagram of an installation angle of the sensor module 110. As illustrated in FIG. 6, the object detection apparatus 100 includes four sensor modules 110, namely a sensor module 110A, a sensor module 110B, a sensor module 110C, and a sensor module 110D. The sensor module 110 is a general term for the sensor module 110A, sensor module 110B, sensor module 110C, and sensor module 110D.

To begin with, the sensor 120 included in the sensor module 110 has a detection range 115 of a first angle that is a detection angle spanning in the in-plane direction of a first plane orthogonal to a first direction. The first direction is an extending direction of the coil axis 213 of the power transmission coil 211. In the present embodiment, the first direction is an extending direction of the Z-axis, and the first plane is the plane 20. In FIG. 7, θ2 is a detection angle spanning in the in-plane direction of the first plane. In the present embodiment, the first angle that is the detection angle is 90 degrees.

The sensor 120 included in the sensor module 110A has a detection range 115A and a non-detection range 116A. The sensor 120 included in the sensor module 110B has a detection range 115B and a non-detection range 116B. The sensor 120 included in the sensor module 110C has a detection range 115C and a non-detection range 116C. The sensor 120 included in the sensor module 110D has a detection range 115D and a non-detection range 116D. The detection range 115 is a general term for the detection range 115A, detection range 115B, detection range 115C and detection range 115D. The non-detection range 116 is a general term for the non-detection range 116A, non-detection range 116B, non-detection range 116C and non-detection range 116D.

Here, an outer edge of the power transmission coil unit 210, as viewed in the first direction, has a shape including a plurality of straight lines 216. Note that the outer edge of the power transmission coil unit 210 is substantially an outer edge of a housing 214 that the power transmission coil unit 210 includes. In the present embodiment, the outer edge of the power transmission coil unit 210, as viewed in the first direction, is referred to simply as the outer edge of the power transmission coil unit 210 where appropriate.

Here, the power transmission coil unit 210, as viewed in the first direction, has a substantially polygonal shape. Specifically, the power transmission coil unit 210, as viewed in the first direction, has a substantially quadrangular shape. Accordingly, the outer edge of the power transmission coil unit 210 has a shape including four straight lines 216, namely a straight line 216A, a straight line 216B, a straight line 216C and a straight line 216D. Note that the straight line 216 is a general term for the straight line 216A, straight line 216B, straight line 216C, and straight line 216D. In addition, in the present embodiment, the straight line is a concept including a line segment.

Here, the plurality of sensors 120 is disposed in a surrounding region 215. The surrounding region 215, as viewed in the first direction, is a region surrounding the power transmission coil unit 210 along the outer edge of the power transmission coil unit 210. The surrounding region 215, as viewed in the first direction, is a strip-shaped region near the periphery of the power transmission coil unit 210. In addition, in the present embodiment, the plurality of sensors 120 is disposed at the vertices of the substantially polygonal shape. In other words, in the present embodiment, the four sensors 120 are disposed near the four vertices of the quadrangle representing the power transmission coil unit 210 in the surrounding region 215.

Specifically, the sensor 120 included in the sensor module 110A is disposed at a position close to one end of the straight line 216A and one end of the straight line 216B in the surrounding region 215. In addition, the sensor 120 included in the sensor module 110B is disposed at a position close to the other end of the straight line 216B and one end of the straight line 216C in the surrounding region 215. The sensor 120 included in the sensor module 110C is disposed at a position close to the other end of the straight line 216C and one end of the straight line 216D in the surrounding region 215. The sensor 120 included in the sensor module 110D is disposed at a position close to the other end of the straight line 216D and the other end of the straight line 216A in the surrounding region 215.

Here, each of the plurality of sensors 120, as viewed in the first direction, is disposed such that an angle formed between the plurality of straight lines 216 overlapping the detection range 115, among the straight lines 216 constituting the outer edge of the power transmission coil unit 210, and the center axis 117 of the detection range 115 is ½ or less of the first angle. In the example illustrated in FIG. 7, the straight line 216 overlapping the detection range 115 of the sensor 120 included in the sensor module 110A, among the four straight lines 216, is the straight line 216A. In addition, the angle formed between the straight line 216A and the center axis 117 of the detection range 115 is θ3. Besides, the first angle that is the detection angle is θ2. Accordingly, each of the plurality of sensors 120 is disposed such that θ3 is ½ or less of θ2.

In the present embodiment, each of the plurality of sensors 120, as viewed in the first direction, is disposed such that the second angle is ½ of the first angle. Accordingly, each of the plurality of sensors 120 is disposed such that θ3 is ½ of θ2. Specifically, the sensor 120 included in the sensor module 110A is disposed such that an end portion of the detection range 115 is positioned along the straight line 216A. In addition, the sensor 120 included in the sensor module 110B is disposed such that an end portion of the detection range 115 is positioned along the straight line 216B. Further, the sensor 120 included in the sensor module 110C is disposed such that an end portion of the detection range 115 is positioned along the straight line 216C. Besides, the sensor 120 included in the sensor module 110D is disposed such that an end portion of the detection range 115 is positioned along the straight line 216D.

As described above, in the present embodiment, each of the plurality of sensors 120, as viewed in the first direction, is disposed in the surrounding region 215 such that the second angle is ½ or less of the first angle. Specifically, in the present embodiment, most of the region near the outer edge of the power transmission coil unit 210 is included in the detection range 115 of the sensor 120. Thus, according to the present embodiment, the detection blind spot near the periphery of the power transmission coil 211 can be reduced.

In particular, in the present embodiment, each of the plurality of sensors 120, as viewed in the first direction, is disposed in the surrounding region 215 such that the second angle is ½ of the first angle. Specifically, in the present embodiment, one end of the detection range 115 of the sensor 120 overlaps the straight line 216 forming the outer edge of the power transmission coil unit 210. Thus, according to the present embodiment, while the broad detection range 115 is being secured, the detection blind spot near the periphery of the power transmission coil 211 can be reduced.

Furthermore, in the present embodiment, the power transmission coil unit 210, as viewed in the first direction, has a substantially polygonal shape, and the plurality of sensors 120 is disposed at the vertices of the substantially polygonal shape. In other words, in the present embodiment, the detection range 115 of the sensor 120 disposed at a certain vertex includes a region along a side having one end at this vertex. Thus, according to the present embodiment, the detection blind angle near the periphery of the power transmission coil 211 can be efficiently reduced by a small number of sensors 120.

### Embodiment 2

In Embodiment 1, the example was described in which the detection ranges of the plurality of sensors 120 do not largely overlap. In the present embodiment, an example is described in which the detection ranges of the plurality of sensors 120 largely overlap. Note that the description of the same configuration and process as in Embodiment 1 is omitted or simplified.

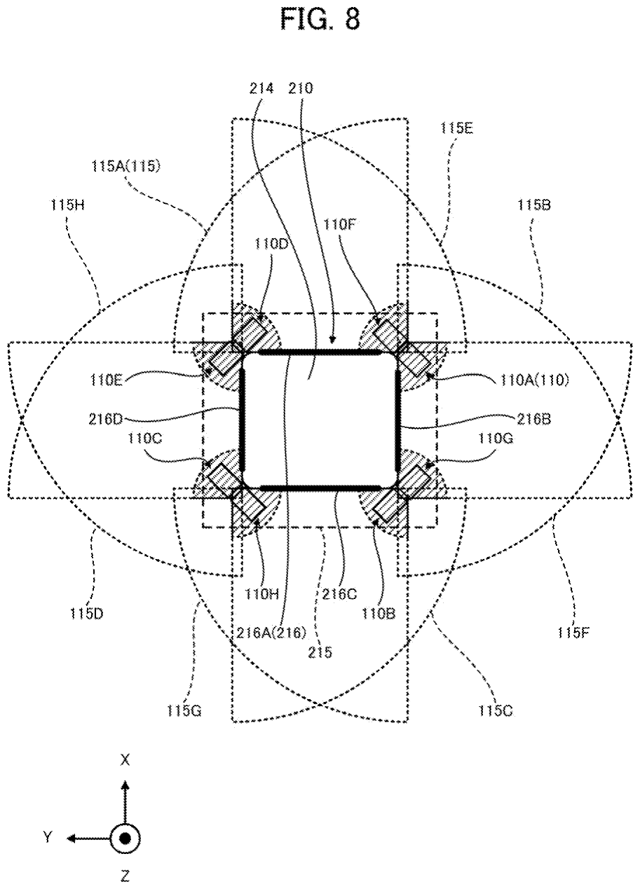

FIG. 8 is an arrangement diagram of eight sensor modules 110 included in the object detection apparatus 100 according to the present embodiment. In the present embodiment, a plurality of sensors 120 comprises four pairs of sensors 120 having mutually overlapping detection ranges 115. Each of the four pairs of sensors 120 is two sensors 120 disposed at both ends of each of the four sides constituting the outer edge of the power transmission coil unit 210.

Specifically, the sensor 120 included in the sensor module 110A disposed at one end of the side corresponding to the straight line 216A and a sensor 120 included in a sensor module 110E disposed at the other end of the side corresponding to the straight line 216A are one pair of sensors 120. In addition, the sensor 120 included in the sensor module 110B disposed at one end of the side corresponding to the straight line 216B and a sensor 120 included in a sensor module 110F disposed at the other end of the side corresponding to the straight line 216B are one pair of sensors 120.

Besides, the sensor 120 included in the sensor module 110C disposed at one end of the side corresponding to the straight line 216C and a sensor 120 included in a sensor module 110G disposed at the other end of the side corresponding to the straight line 216C are one pair of sensors 120. In addition, the sensor 120 included in the sensor module 110D disposed at one end of the side corresponding to the straight line 216D and a sensor 120 included in a sensor module 110H disposed at the other end of the side corresponding to the straight line 216D are one pair of sensors 120.

The eight sensors 120 are disposed in the surrounding region 215 that is, as viewed in the first direction, a region surrounding the power transmission coil unit 210 along the outer edge of the power transmission coil unit 210. In addition, each of the eight sensors 120, as viewed in the first direction, is disposed such that the second angle is ½ of the first angle. Besides, the power transmission coil unit 210, as viewed in the first direction, has a substantially quadrangular shape. The eight sensors 120 are disposed two by two at the four vertices of the substantially quadrangular shape.

Note that two sensors 120 disposed at one vertex are preferably disposed not to interfere with each other's sensing. For example, the two sensors 120 disposed at one vertex may be situated at different positions in the Z-axis direction. Alternatively, the two sensors 120 disposed at one vertex may be situated at the same position in the Z-axis direction, if the two sensors 120 do not interfere with each other's sensing.

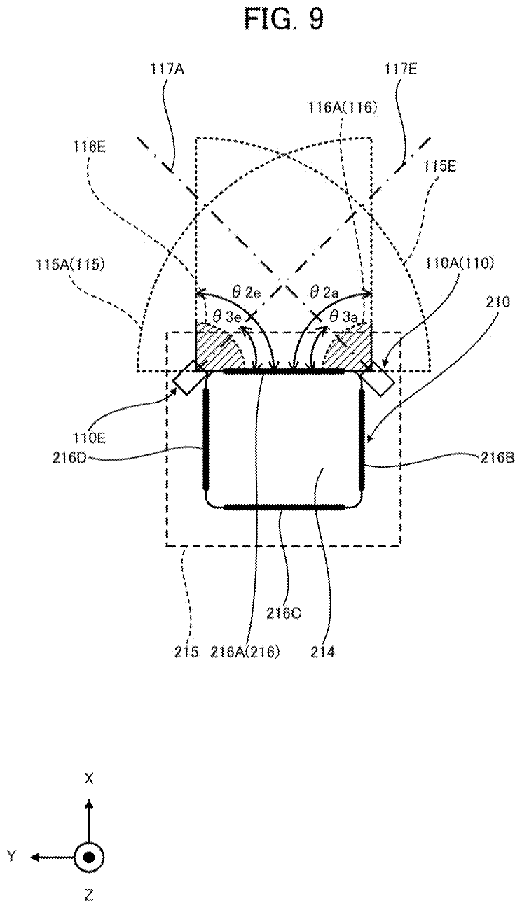

Here, a plurality of pairs of the sensors 120 is disposed such that the detection range 115 of one sensor 120 includes at least a part of the other sensor 120, and that the detection range 115 of the other sensor 120 includes at least a part of the one sensor 120. Hereinafter, referring to FIG. 9, a description is given of the arrangement of one pair of sensors 120 including the sensor 120, which the sensor module 110A includes, and the sensor 120, which the sensor module 110E includes.

The sensor 120 included in the sensor module 110A is disposed near one end of a side including the straight line 216A. The detection range 115A is the detection range 115 of the sensor 120 included in the sensor module 110A. The non-detection range 116A is the non-detection range 116 of the sensor 120 included in the sensor module 110A. A center axis 117A is the center axis of the detection range 115A. θ2a is a detection angle spanning in the in-plane direction of the first plane in the detection range 115A. θ3a is an angle formed between the straight line 216A and the center axis 117A. The sensor 120 included in the sensor module 110A is disposed such that θ3a is ½ of θ2a.

The sensor 120 included in the sensor module 110E is disposed near the other end of the side including the straight line 216A. A detection range 115E is the detection range 115 of the sensor 120 included in the sensor module 110E. A non-detection range 116E is the non-detection range 116 of the sensor 120 included in the sensor module 110E. A center axis 117E is the center axis of the detection range 115E. θ2e is a detection angle spanning in the in-plane direction of the first plane in the detection range 115E. θ3e is an angle formed between the straight line 216A and the center axis 117E. The sensor 120 included in the sensor module 110E is disposed such that θ3e is ½ of θ2e.

Here, the detection range 115A includes at least a part of the sensor 120 included in the sensor module 110E, and the detection range 115E includes at least a part of the sensor 120 included in the sensor module 110A. Thus, the detection range 115A and the detection range 115E, as viewed in the first direction, largely overlap in the vicinity of the straight line 216A. In addition, in the present embodiment, the entirety of the non-detection range 116E, as viewed in the first direction, overlaps the detection range 115A, and the entirety of the non-detection range 116A, as viewed in the first direction, overlaps the detection range 115E. Accordingly, no detection blind spot exists in the vicinity of the straight line 216A.

In addition, the detection range 115B includes at least a part of the sensor 120 included in the sensor module 110F, and the detection range 115F includes at least a part of the sensor 120 included in the sensor module 110B. Thus, the detection range 115B and the detection range 115F, as viewed in the first direction, largely overlap in the vicinity of the straight line 216B. In addition, in the present embodiment, the entirety of the non-detection range 116F, as viewed in the first direction, overlaps the detection range 115B, and the entirety of the non-detection range 116B, as viewed in the first direction, overlaps the detection range 115F. Accordingly, no detection blind spot exists in the vicinity of the straight line 216B.

Furthermore, the detection range 115C includes at least a part of the sensor 120 included in the sensor module 110G, and the detection range 115G includes at least a part of the sensor 120 included in the sensor module 110C. Thus, the detection range 115C and the detection range 115G, as viewed in the first direction, largely overlap in the vicinity of the straight line 216C. In addition, in the present embodiment, the entirety of the non-detection range 116G, as viewed in the first direction, overlaps the detection range 115C, and the entirety of the non-detection range 116C, as viewed in the first direction, overlaps the detection range 115G. Accordingly, no detection blind spot exists in the vicinity of the straight line 216C.

Besides, the detection range 115D includes at least a part of the sensor 120 included in the sensor module 110H, and the detection range 115H includes at least a part of the sensor 120 included in the sensor module 110D. Thus, the detection range 115D and the detection range 115H, as viewed in the first direction, largely overlap in the vicinity of the straight line 216D. In addition, in the present embodiment, the entirety of the non-detection range 116H, as viewed in the first direction, overlaps the detection range 115D, and the entirety of the non-detection range 116D, as viewed in the first direction, overlaps the detection range 115H. Accordingly, no detection blind spot exists in the vicinity of the straight line 216D.

In this manner, no detection blind spot exists in the vicinity of the straight line 216A, straight line 216B, straight line 216C or straight line 216D. In other words, in the present embodiment, each of all regions included in the surrounding region 215 is included in the detection range 115 of any one of the plurality of sensors 120.

In the present embodiment, the plurality of tpairs of the sensors 120 that the detection ranges 115 overlap each other, is disposed such that the detection range of one sensor 120 includes at least a part of the other sensor 120, and that the detection range of the other sensor 120 includes at least a part of the one sensor 120. Thus, according to the present embodiment, the detection blind spot near the periphery of the power transmission coil 211 can further be reduced.

Additionally, according to the present embodiment, the object 30 disposed in a detection range where the detection ranges 115 overlap each other can exactly be detected. Moreover, according to the present embodiment, even when one of the paired sensors 120 is unable to perform detection because of damage or adhesion of contamination, the detection function can be maintained in regard to the overlapping detection range.

Additionally, according to the present embodiment, each of all regions included in the surrounding region 215 is included in the detection range 115 of any one of the plurality of sensors 120. Thus, according to the present embodiment, the detection blind spot near the periphery of the power transmission coil 211 can further be reduced.

### Embodiment 3

In Embodiments 1 and 2, the example was described in which the power transmission coil unit 210, as viewed in the first direction, has the substantially quadrangular shape. In the present embodiment, an example is described in which a power transmission coil unit 210A, as viewed in the first direction, has a substantially hexagonal shape. Note that the description of the same configuration and process as in Embodiments 1 and 2 is omitted or simplified.

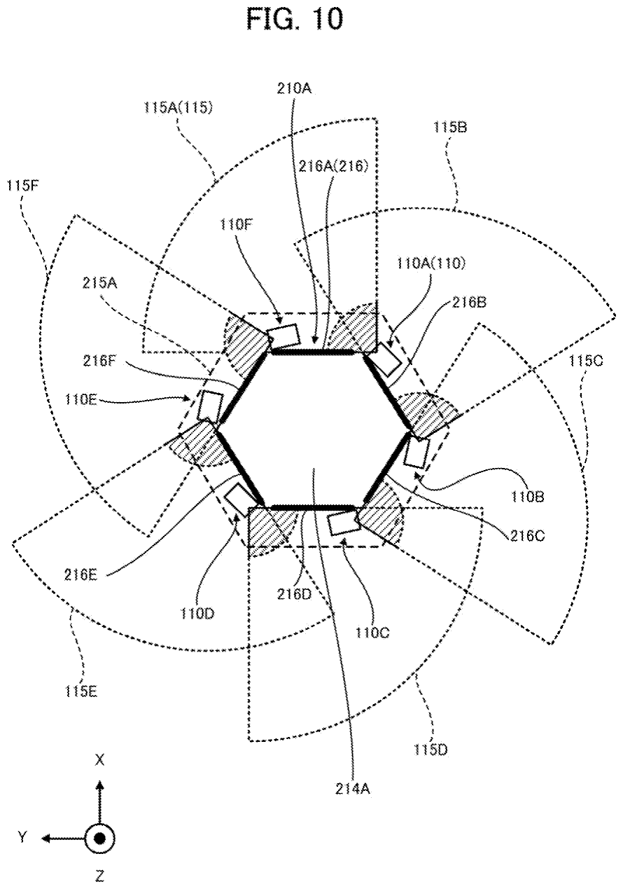

FIG. 10 is an arrangement diagram of six sensor modules 110 included in the object detection apparatus 100 according to the present embodiment. In the present embodiment, an outer edge of the power transmission coil unit 210A, as viewed in the first direction, has a substantially hexagonal shape. The outer edge of the power transmission coil unit 210A is substantially an outer edge of a housing 214A that the power transmission coil unit 210A includes. The substantially hexagonal shape includes six sides, which comprise a side including a straight line 216A, a side including a straight line 216B, a side including a straight line 216C, a side including a straight line 216D, a side including a straight line 216E and a side including a straight line 216F, and six vertices that are each connected to two corresponding sides among these six sides.

The sensor module 110A is disposed near the vertex connected to the side including the straight line 216A and the side including the straight line 216B. The sensor module 110B is disposed near the vertex connected to the side including the straight line 216B and the side including the straight line 216C. The sensor module 110C is disposed near the vertex connected to the side including the straight line 216C and the side including the straight line 216D. The sensor module 110D is disposed near the vertex connected to the side including the straight line 216D and the side including the straight line 216E. The sensor module 110E is disposed near the vertex connected to the side including the straight line 216E and the side including the straight line 216F. The sensor module 110F is disposed near the vertex connected to the side including the straight line 216F and the side including the straight line 216A.

The six sensors 120 are disposed in a surrounding region 215A that is, as viewed in the first direction, a region surrounding the power transmission coil unit 210A along the outer edge of the power transmission coil unit 210A. In addition, each of the six sensors 120, as viewed in the first direction, is disposed such that the second angle is ½ of the first angle.

In the present embodiment, each of the plurality of sensors 120, as viewed in the first direction, is disposed in the surrounding region 215A such that the second angle is ½ of the first angle. Thus, according to the present embodiment, while the broad detection range 115 is being secured, the detection blind spot near the periphery of the power transmission coil 211 can be reduced.

Furthermore, in the present embodiment, the power transmission coil unit 210A, as viewed in the first direction, has a substantially polygonal shape, and the sensors 120 are disposed at the vertices of the substantially polygonal shape. Thus, according to the present embodiment, the detection blind angle near the periphery of the power transmission coil 211 can be efficiently reduced by a small number of sensors 120.

### Embodiment 4

In Embodiment 1, the example was described in which each of the plurality of sensors 120, as viewed in the first direction, is disposed in the surrounding region 215 such that the second angle is ½ of the first angle. In the present embodiment, an example is described in which each of the plurality of sensors 120, as viewed in the first direction, is disposed in the surrounding region 215 such that the second angle is less than ½ of the first angle. Note that the description of the same configuration and process as in Embodiments 1 to 3 is omitted or simplified.

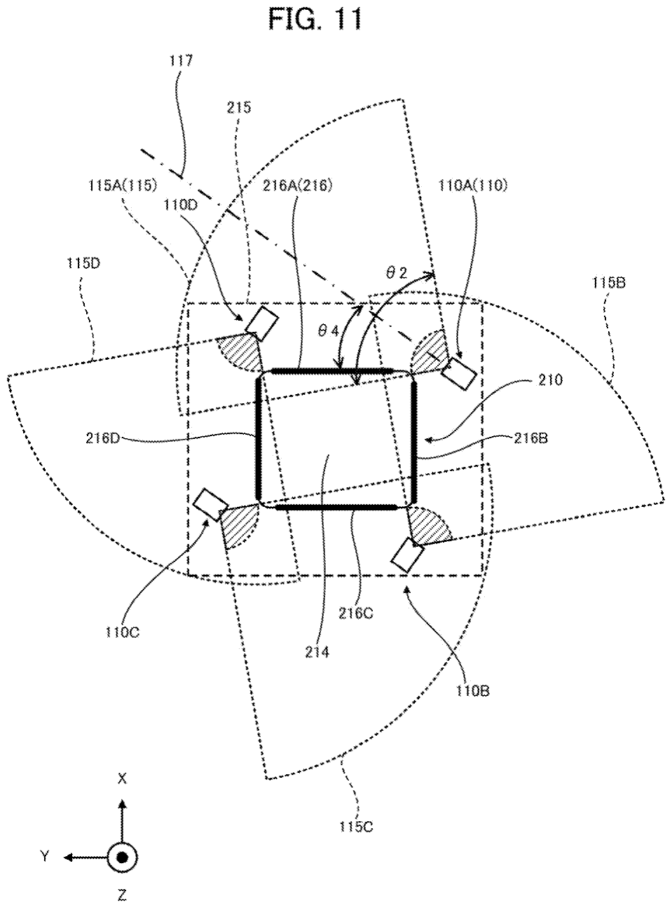

FIG. 11 is an arrangement diagram of four sensor modules 110 included in the object detection apparatus 100 according to the present embodiment. In the present embodiment, too, the four sensors 120 are disposed near the four vertices of the quadrangle representing the power transmission coil unit 210 in the surrounding region 215. θ2 is a detection angle spanning in the in-plane direction of the first plane. In the present embodiment, the first angle that is the detection angle is 90 degrees. θ4 is an angle formed between the straight line 216 overlapping the detection range 115, as viewed in the first direction, among the four straight lines 216, and the center axis 117 of the detection range 115. In the present embodiment, each of the plurality of sensors 120 is disposed such that θ4 is less than ½ of θ2.

Specifically, the sensor 120 included in the sensor module 110A is disposed such that an end portion of the detection range 115 is located more on the center side of the power transmission coil unit 210 than the straight line 216A. In addition, the sensor 120 included in the sensor module 110B is disposed such that an end portion of the detection range 115 is located more on the center side of the power transmission coil unit 210 than the straight line 216B. Further, the sensor 120 included in the sensor module 110C is disposed such that an end portion of the detection range 115 is located more on the center side of the power transmission coil unit 210 than the straight line 216C. Besides, the sensor 120 included in the sensor module 110D is disposed such that an end portion of the detection range 115 is located more on the center side of the power transmission coil unit 210 than the straight line 216D.

Additionally, in the present embodiment, the entirety of the non-detection range 116 of a certain sensor 120 is included in the detection range 115 of another sensor 120. Specifically, the entirety of the non-detection range 116 of the sensor 120 included in the sensor module 110A is included in the detection range 115B of the sensor 120 included in the sensor module 110B. In addition, the entirety of the non-detection range 116 of the sensor 120 included in the sensor module 110B is included in the detection range 115C of the sensor 120 included in the sensor module 110C.

Besides, the entirety of the non-detection range 116 of the sensor 120 included in the sensor module 110C is included in the detection range 115D of the sensor 120 included in the sensor module 110D. In addition, the entirety of the non-detection range 116 of the sensor 120 included in the sensor module 110D is included in the detection range 115A of the sensor 120 included in the sensor module 110A. As a result, in the present embodiment, each of all regions included in the surrounding region 215 is included in the detection range 115 of any one of the plurality of sensors 120.

In the present embodiment, each of the plurality of sensors 120, as viewed in the first direction, is disposed in the surrounding region 215 such that the second angle is less than ½ of the first angle. Specifically, in the present embodiment, an end portion of the detection range 115 of the sensor 120 is located more on the center side of the power transmission coil unit 210 than the straight line 216 that constitutes the outer edge of the power transmission coil unit 210. Thus, according to the present embodiment, the detection blind spot near the periphery of the power transmission coil 211 can be reduced.

Furthermore, in the present embodiment, the power transmission coil unit 210, as viewed in the first direction, has a substantially polygonal shape, and the plurality of sensors 120 is disposed at the vertices of the substantially polygonal shape. Thus, according to the present embodiment, the detection blind angle near the periphery of the power transmission coil 211 can be efficiently reduced by a small number of sensors 120.

Additionally, in the present embodiment, each of all regions included in the surrounding region 215 is included in the detection range 115 of any one of the plurality of sensors 120. Thus, according to the present embodiment, the detection blind angle near the periphery of the power transmission coil 211 can further be reduced.

### Embodiment 5

In Embodiment 1, the example was described in which the plurality of sensor modules 110 and the power transmission coil unit 210 are separately disposed. In the present embodiment, an example is described in which the plurality of sensor modules 110 is provided as one body with the power transmission coil unit 210. Note that the description of the same configuration and process as in Embodiment 1 is omitted or simplified.

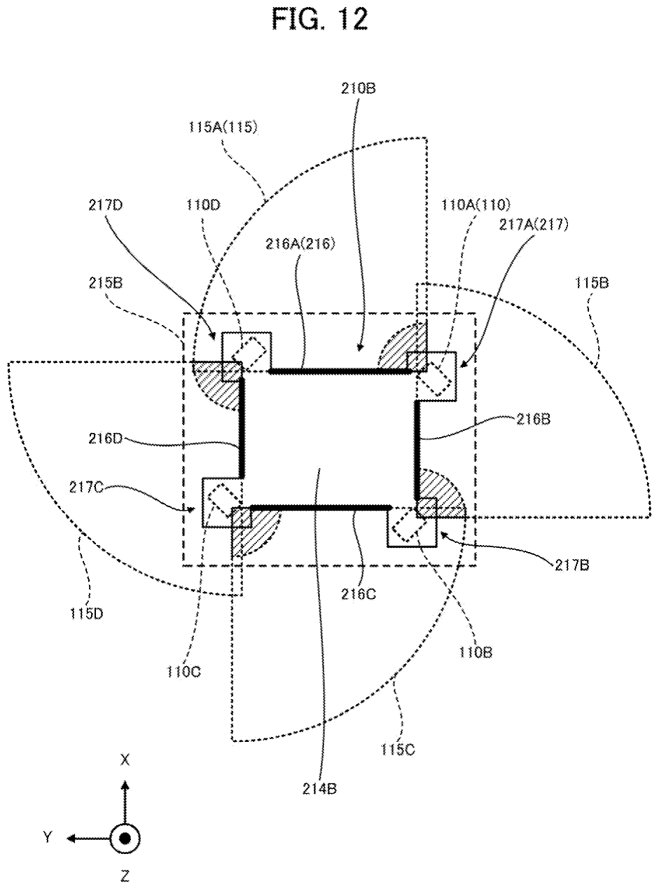

FIG. 12 is an arrangement diagram of sensor modules 110 according to the present embodiment. In the present embodiment, a power transmission coil unit 210B includes a housing 214B that accommodates the power transmission coil 211, and the plurality of sensor modules 110 is accommodated in the housing 214B that the power transmission coil unit 210B includes. Specifically, in the present embodiment, four sensor modules 110 are assembled in the inside of the housing 214B of the power transmission coil unit 210B.

Specifically, the housing 214B includes a storing portion 217A that stores the sensor module 110A, a storing portion 217B that stores the sensor module 110B, a storing portion 217C that stores the sensor module 110C, and a storing portion 217D that stores the sensor module 110D. The housing 214B has a substantially quadrangular shape in plan view, and includes the storing portion 217A, storing portion 217B, storing portion 217C and storing portion 217D at the four corners thereof.

In the present embodiment, the housing 214B functions as a housing of the four sensor modules 110, and the four sensor modules 110 do not include housings 160. Note that opening portions are provided in those parts of the housing 214B, which are opposed to the detection windows 121. The storing portion 217 is a general term for the storing portion 217A, storing portion 217B, storing portion 217C and storing portion 217D.

In the present embodiment, too, each of the plurality of sensors 120, as viewed in the first direction, is disposed in a surrounding region 215B such that the second angle is ½ of the first angle. Thus, according to the present embodiment, while the broad detection range 115 is being secured, the detection blind spot near the periphery of the power transmission coil 211 can be reduced.

In addition, in the present embodiment, the power transmission coil unit 210, as viewed in the first direction, has a substantially polygonal shape, and the plurality of sensors 120 is disposed at the vertices of the substantially polygonal shape. Thus, according to the present embodiment, the detection blind angle near the periphery of the power transmission coil 211 can be efficiently reduced by a small number of sensors 120.

Furthermore, in the present embodiment, a plurality of sensor modules 110 is accommodated in the housing 214B that the power transmission coil unit 210B includes. Thus, according to the present embodiment, the time and labor for arranging the plurality of sensor modules 110 can be reduced.

(Modifications)

While the embodiments of the present disclosure have been described above, modifications and applications in various modes can be made in implementing the present disclosure. In the present disclosure, which part of the structures, functions and operations described in the above embodiments is to be adopted is discretionary. In addition, in the present disclosure, besides the above-described structures, functions and operations, other structures, functions and operations may be adopted. The above-described embodiments may freely be combined as appropriate. The number of structural elements described in the embodiments can be adjusted as appropriate. Furthermore, needless to say, the materials, sizes, electrical characteristics, and the like, which can be adopted in the present disclosure, are not limited to those in the above-described embodiments.

In Embodiment 1, the example was described in which the outer shape of the power transmission coil unit 210, as viewed in the first direction, is the quadrangle, and the number of sensors 120 is four. The outer shape of the power transmission coil unit 210 may be a triangle, and the number of sensors 120 may be three. In addition, the outer shape of the power transmission coil unit 210 may be a polygon having five or more vertices, and the number of sensors 120 may be the same as the number of vertices. Besides, the outer shape of the power transmission coil unit 210, as viewed in the first direction, may not be a polygon. For example, as the outer shape of the power transmission coil unit 210 as viewed in the first direction, various shapes including straight lines and curves may be adopted.

In Embodiment 1, the example was described in which the ultrasonic sensor was adopted as the sensor 120 that is used for detecting the object 30. Various types of sensors can be adopted as the sensor 120. For example, as the sensor 120, a millimeter-wave sensor, an X-band sensor, an infrared sensor, and a visible-light sensor can be adopted. In addition, in Embodiment 1, the example was described in which the first angle that is the detection angle spanning in the in-plane direction of the first plane orthogonal to the first direction is 90 degrees. The first angle may be an angle less than 90 degrees, or may be an angle greater than 90 degrees.

By applying the operation program, which defines the operation of the object detection apparatus 100 according to the present disclosure, to a computer such as an existing personal computer or information terminal apparatus, this computer can be caused to function as the object detection apparatus 100 according to the present disclosure. In addition, a method of distributing the program may be freely chosen, and the program may be distributed by being stored in a non-transitory computer-readable recording medium such as a compact disk ROM (CD-ROM), a digital versatile disk (DVD), a magneto-optical disk (MO) or a memory card, or may be distributed via a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A power transmission apparatus, comprising:
a power transmission coil unit including a power transmission coil formed such that a lead wire is spirally wound around a coil axis extending in a first direction, the power transmission coil unit wirelessly transmitting electric power to a power receiving apparatus;
a plurality of sensor modules each including a sensor and a controller, the sensor having a detection range of a first angle that is a detection angle spanning in an in-plane direction of a first plane orthogonal to the first direction, the controller being configured to control the sensor and generate output information based on a signal that the sensor outputs; and
a detector that determines presence or absence of an object, based on the output information, wherein
an outer edge of the power transmission coil unit, as viewed in the first direction, has a shape including a plurality of straight lines,
the plurality of sensors is disposed in a surrounding region that is, as viewed in the first direction, a region surrounding the power transmission coil unit along the outer edge of the power transmission coil unit, and
each of the plurality of sensors, as viewed in the first direction, is disposed such that a second angle that is an angle formed between a straight line overlapping the detection range, among the plurality of straight lines constituting the outer edge of the power transmission coil unit, and a center axis of the detection range is ½ or less of the first angle.

2. The power transmission apparatus according to claim 1, wherein each of the plurality of sensors, as viewed in the first direction, is disposed such that the second angle is ½ of the first angle.

3. The power transmission apparatus according to claim 1, wherein each of all regions included in the surrounding region is included in the detection range of any one of the plurality of sensors.

4. The power transmission apparatus according to claim 1, wherein the power transmission coil unit, as viewed in the first direction, has a substantially polygonal shape, and the plurality of sensors is disposed at vertices of the substantially polygonal shape.

5. The power transmission apparatus according to claim 1, wherein
the plurality of sensors comprises a plurality of pairs of sensors having mutually overlapping detection ranges, and
the plurality of pairs of the sensors is disposed such that a detection range of one sensor includes at least a part of the other sensor, and that a detection range of the other sensor includes at least a part of the one sensor.

6. The power transmission apparatus according to claim 1, wherein each of the plurality of sensor modules includes an electromagnetic shielding member that covers at least a part of the sensor.

7. The power transmission apparatus according to claim 1, wherein
the power transmission coil unit includes a housing that accommodates the power transmission coil, and
the plurality of sensor modules is accommodated in the housing that the power transmission coil unit includes.

8. A power transmission system, comprising:
the power transmission apparatus according to claim 1; and
a power receiving apparatus that receives electric power from the power transmission apparatus.
